(19) United States
(12) Patent Application Publication
(10) Pub. No.: US 2015/0332350 A1
(43) Pub. Date: Nov. 19, 2015

(54) SYSTEM AND METHOD FOR MANAGING A PROMOTIONAL EVENT ON SOCIAL PLATFORMS

(71) Applicant: CDK Global, Inc., Hoffman Estates, IL (US)

(72) Inventors: Sarah Gauss, Houston, TX (US); Andrew Largent, Seattle, WA (US)

(73) Assignee: CDK Global, Inc., Hoffman Estates, IL (US)

(21) Appl. No.: 14/279,056

(22) Filed: May 15, 2014

(51) Int. Cl. G06Q 30/02; G06F 17/30

(52) U.S. Cl. CPC G06Q 30/0276; G06F 17/30244; G06F 17/30882; G06F 17/30864; G06Q 30/0277; G06Q 50/01

(57) ABSTRACT

A method and system of creating social media promotional content. The method and system includes receiving, by at least one computing device, a promotional event involving a third party, generating, by the at least one computing device, a consent request to obtain consent from the third party to publish the promotional event, generating, by the at least one computing device, a first social media post based on the promotional event to publish at a first social media website; and generating, by the at least one computing device, a second social media post based on the promotional event to publish at a second social media website. The first media post and the second media post each contains a unique identifier.

### BACKGROUND

1. Field of the Present Disclosure

The present application relates generally to systems and methods for managing social media contents. More specifically, the present application relates to systems and methods for capturing, creating, publishing, and reviewing social media contents associated with a promotion event.

2. Background Discussion

Social networking websites allow individuals to interact with one another and build relationships. When companies join the social channels, consumers can interact with them and they can communicate with consumers directly. Social networking sites, including blogs, allow individual followers to “retweet” or “repost” comments made by the product being promoted. This kind of personal interactions can generate a feeling of loyalty into followers and potential customers. Also, by choosing whom to follow on these sites, products can reach a very narrow target audience, Presently, almost every company, agency, firms, political campaign, or social event has its own channel or means on social networking platforms to market their brands, product, candidate, and services.

For example, it is not uncommon for car dealerships to utilize various communication or interaction components available on computer networks to advertise and promote their businesses. For example, car dealerships routinely use online advertisements to promote their sales. Car dealerships sometimes use blogs on their own websites to post information about sales specials, car maintenance recommendations, safe-driving tips, or other advertisements. Their websites may also have individual webpages dedicated to a sales representative. These webpages may contain information related to the representative's background, qualifications, training, or specialty.

Additionally, car dealerships utilize social media platforms to build and maintain a social network. with their customers. For example, car dealerships can set up their own channel or page on a social network and provide their current or potential customers with icons that directly link to the car dealership's specific social media page on Facebook. Twitter, or YouTube. Moreover, individual sales representatives can advertise their own sales on their personal social media pages.

However, the above-discussed websites and social network platforms do not provide a capability to automobile dealerships to allow them to advertise their sales within a customer's own social network, which would allow for a localized yet widespread advertising campaign. The currently available websites and social network platforms do not integrate the advertisement creation, review, and post-publication analysis into a package so that a dealer can effectively manage the entire life cycle of a promotional event.

### SUMMARY OF THE INVENTION

A networked-based system is needed to effectively deliver advertising options to targeted audience in order to increase the awareness of a brand, a sales event, or a candidate. Systems and methods that advertise a sale within the customer's own social network are also needed, Additionally, systems and methods that allow a dealership to integrate all components of its social media presence, monitor individual sales postings to ensure that the content is in accordance with overall advertising objectives, and to monitor feedback related to its social media content are also needed. These technologies will allow a dealership to ensure that its branding is consistent throughout its entire social media presence, and will allow for enhanced monitoring of such content.

According to an aspect, the present application is directed to a computer implemented method of creating social media promotional content. The method comprises receiving, by at least one computing device, a promotional event involving a third party, generating, by the at least one computing device, a consent request to obtain consent from the third party to publish the promotional event, generating, by the at least one computing device, a first social media post based on the promotional event to publish at a first social media website; and generating, by the at least one computing device, a second social media post based on the promotional event to publish at a second social media website. The first media post and the second media post each contains a unique identifier.

According to another aspect, the present application is directed to a computer system for creating social media promotional content. The system comprises a receiving section that receives a promotional event involving a third party, a generating section that generates a Consent request to obtain consent from the third party to publish the promotional event, a first social media post based on the promotional event to publish at a first social media website; and generating a second social media post based on the promotional event to publish at a second social media website. The first media post and the second media post each contains a unique identifier.

According to yet another aspect, the present application is directed to a computer implemented method of creating social media promotional content. The method comprising receiving, by at least one computing device, a social media post by a third party; generating, by the at least one computing device, a first social media post based on the social media post by the third party to publish at a first social media website; and generating, by the at least one computing device, a second media post based on the social media post by the third party to publish at a second media website. The first social media post and the second social media post each contains a unique identifier.

According to an embodiment, the method further comprises reviewing, by the at least one computing device, at least one response to the first social media post and at least one response to the second media post; and generating, by the at least one computing device, additional social media posts based on the social media post by the third party.

According to another embodiment, the method further comprises selecting, by the at least one computing device, from a plurality of social media posts by the third party, one social media post as a promotional event; and generating, by the at least one computing device, a social media post based on the promotional event.

According to certain embodiments, the promotional event includes an image uploaded by a user, a video uploaded by a user, an URL, and/or a social media post.

According to yet another embodiment, the social platform includes a blog.

According to yet another embodiment, the unique identifier is an embedded text.

According to yet another embodiment, the promoting event involves sale of an item by a promotional entity.

According to yet another embodiment, the first social media website is a blog.

According to yet another aspect, the present application is directed to a computer-readable medium having computer-executable instructions for executing the various methods as described in the present application.

### BRIEF DESCRIPTION OF DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present application is intended to include all such aspects and their equivalents. Other advantages, embodiments and novel features of the invention may become apparent from the following description of the present invention when considered in conjunction with the drawings. The following description, given by way of example, but not intended to limit the present invention solely to the specific embodiments described, may best be understood in conjunction with the accompanying drawings, in which:

FIG. 1 illustrates an embodiment of a social media management system 100.

FIG. 2 illustrates an embodiment of an electronic device 200 capable of being used with the social media management system.

FIG. 3a illustrates a social media management method 300 according to an embodiment of the present application.

FIG. 3b illustrates a social media creation method 310 according to an embodiment of the present application.

FIG. 4a illustrates a method 400 for obtaining consent from a party according to an embodiment of the present application.

FIG. 4b illustrates a method 408 for creating a social media post according to an embodiment of the present application.

FIG. 4c illustrates a method 424 for reviewing a social media post according to an embodiment of the present application.

FIG. 5 illustrates a method 500 for the post publication management of social media responses and posts according to an embodiment of the present application.

FIG. 6 illustrates a method 600 for analyzing social media data according to an embodiment of the present application.

FIG. 7 illustrates a method 700 for analyzing social media data according to an embodiment of the present application.

FIG. 8 illustrates a method 800 for scheduling the publication of a social media post according to an embodiment of the present application.

FIG. 9 illustrates a screen 900 for reviewing social media data according to an embodiment of the present application.

FIG. 10 illustrates a dashboard screen 1000 for managing social media contents according to an embodiment of the present application.

### DETAILED DESCRIPTION

Those of ordinary skill in the art will realize that the description of the present invention is illustrative only and not in any way limiting. Other embodiments will readily suggest themselves to such skilled persons, having the benefit of this disclosure. Reference will be made in detail to specific implementations of the present invention as illustrated in the accompanying drawings.

Further, certain figures in this specification are flow charts illustrating methods and systems. It will be understood that each block of these flow charts, and combinations of blocks in these flow charts, must be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory or a storage medium that can direct a computer or other programmable apparatus to function in a particular manner, such that the instructions stored in the computer-readable memory or storage medium produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions, It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (CSharp), Perl, Ada, Ruby, Python, Pascal, SmallTalk, FORTRAN, assembly language, and the like, may be used to implement aspects of the present application. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of functions.

The term “machine-readable medium” or “storage medium” can be understood to include any structure that participates in providing data which may be read by an element of a computer system. Such a medium may take many forms, including but not limited to, non-volatile media, volatile media, and transmission media, Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, a compact flash card, a smart media cart, a SMS card, any other magnetic medium, a CD-ROM, a DVD, or any other optical medium.

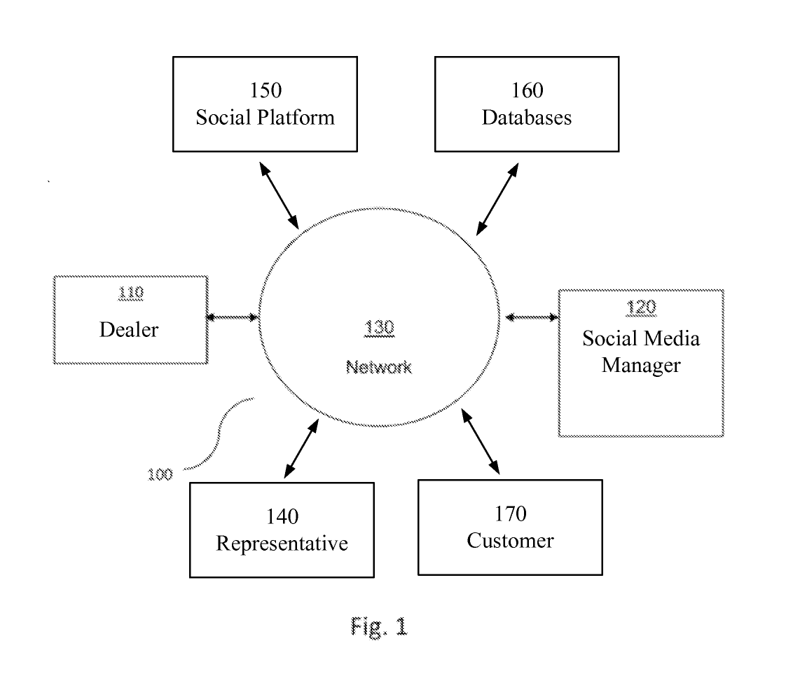

FIG. 1 illustrates a social media management system 100 according to an embodiment of the present application. As illustrated, the social media management system 100 includes dealer terminals 110, social medial manager terminals 120, networks 130, representative terminals 140, social platforms 150, databases 160, and customer terminals 170. The exemplary simplified number of terminals illustrated in FIG. 1 can he modified as appropriate in a particular implementation. in practice, there may be additional dealer terminals 110, social medial manager terminals 120, networks 130, representative terminals 140, social platforms 150, databases 160, and representative terminals 170.

The dealer terminal 110 may be any device used by an employee of a dealership to access the network 130. The terminal 110 may be a computer, laptop, tablet, phone, mobile phone, or any other electronic devices that is capable of retrieving information via the network 130 and presenting retrieved information to a user. According to an embodiment, a dealership represents an automobile dealership. According to another embodiment, a dealership may include any type of business entities from for-profit organizations to non-profit organizations as long as they buy or sell on behalf of another company or organization. According to an embodiment, the dealership represents a government agency. The areas of business are not limited to automobiles, but also include antique, art, machine, consumer goods, bonds and/or securities. According to an embodiment, the social media management system 100 provides functions to the dealer and their employees to create a promotional event by using contents associated with a real customer, to make promotions among a local customer base, and to reply to trends of reviews and comments on a social network, thus effectively managing the image and reputation of the dealership on a social network.

A promotional event may include any activity, effort, publication, incentives, discounts, advertisement, or any material that aims to raise customer awareness of a product or brand, generate sales, and/or create brand loyalty. According to an embodiment, a promotion event represents a social media post to be published on a social platform in order to raise customer awareness of a product or brand, generate sales, and create brand loyalty. The social medial post may include an icon, text messages, a In an image, and/or videos.

By an implementation of the present application, after a customer completes a transaction with a dealer, such as buying a car, a dealer may be able to use the experience of the customer to create a promotional event. With or without incentives, a customer may be willing to provide his or her efforts that assist the dealer to raise its reputation or the awareness of a sales event. For example, the customer may make a pose with the goods he or she just has just purchased and allows the dealer to take a picture or video of the happy scene. The customer may also accept an interview with the dealer's representative and talk about his or her experiences during the transaction. The customer may also post his or her story, image, or video on a social platform by himself or herself. The dealer may use any of these materials to create a promotional event, such as a social media post, to raise the reputation and/or brand loyalty and/or increase sales.

According to an embodiment, the representative terminal 140 is used by an employee of a dealer and may be used to create a promotional event. The dealer terminal 110 may he used by a social media manager to review and edit the promotional event. The social platform 150 is used for the publication of the promotional event. The social media manager terminal 120 may be used for creating, reviewing, editing, and publishing a promotional event and may also to be used for monitoring and analyzing social media data, such as responses to the promotional event. The customer terminal 170 may be used by a customer to interact with the dealer, the representative, the social platform, and the social media manager. According to an embodiment, some or all of the dealer terminal 110, the representative terminal 140, the customer terminal 170, and/or the social media manager terminal 120 may be combined or may be represented by one terminal without affecting the functions thereof.

According to an embodiment, the social media management system 100 provides a browser based interface to a user. The user may use an electronic device, such as a server, a computer, a mobile phone, a tablet, a laptop, or a TV, to connect to the network and the social media manager terminal 120. The system 100 may allow a user to install dedicated software on an electronic device and execute the software to make connections to the social media manager terminal 120 and input data. According to an embodiment, the social media manager terminal 120 may be associated with any of the terminals as shown in FIG. 1 through any suitable tangible computer-readable media or data storage device (such as a disk drive, CD-ROM, DVD, or the like).

Network 130 may include one or more networks of any type, including a Public Land Mobile Network (PLMN), a telephone network (e.g., a Public Switched Telephone Network (PSTN) and/or a wireless network), a local part network (LAN), a metropolitan part network (MAN), a wide part network (WAN), an Internet Protocol Multimedia Subsystem (IMS) network, a private network, the Internet, an intranet, and/or another type of suitable network, depending on the requirements of each particular implementation.

The social platform includes social media or social network websites, such as Facebook, Google+, MySpace, and FourSquare. Social media platforms also include information networks or social information networks such as Twitter, YouTube, Flickr, and Digg. Social media platforms also include those network functions, such as blogs, bulletin board, comment board, discussion page, or advice page on edmunds.com, bluebook.com, cars.com, or a dealer's website, that facilitate to a greater extent participatory information sharing, interoperability, user-centered design, and collaboration than Web 1.0 websites. The social platform 150 may represent many terminals operated by a same party and allow input from many countries in many languages.

The databases 160 may be a centralized server, several connected and distributed servers, or a cloud based storage system. The database 160 stores business information of a dealer, which includes promotional events, current and historical sales information, inventory, customer information, employee information, projections, information of new models, and etc. The database 160 also Stores consent of a third party that authorizes the dealer to use the third party's information in a promotional event and social media data associated with the promotional event.

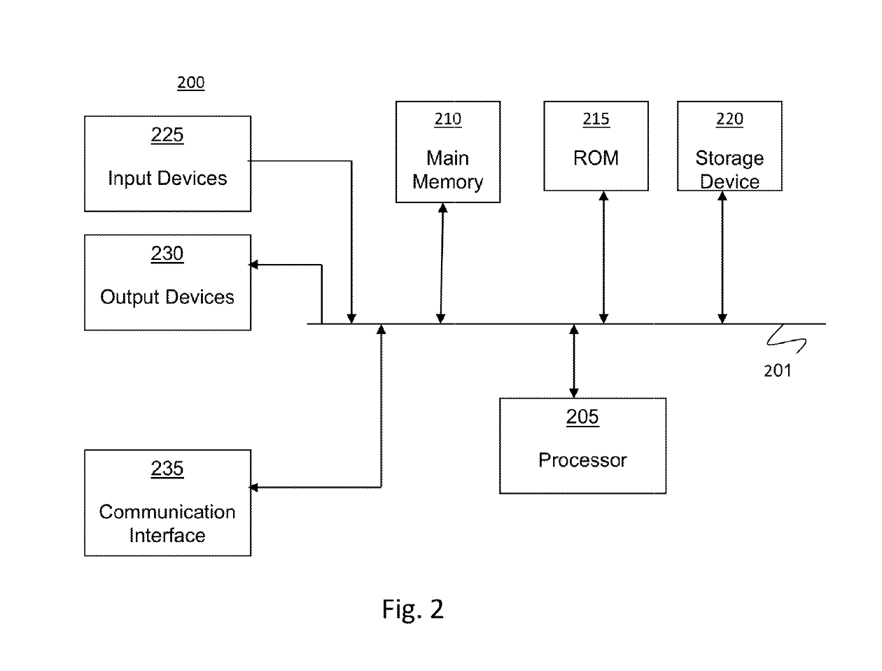

FIG. 2 is an exemplary diagram of an electronic device 200 that may be used to implement aspects of certain embodiments of the present application, such as aspects of the dealer terminals 110, social media manager terminals 120, networks 130, representative terminals 140. social platform 150, databases 160, and customer terminals 170. The following examples illustrate a few implementations of the electronic device, including any desktop computer, any laptop, any server, any tablet such as iPad, any mobile phone such as iPhone, any computer device designed for a general or particular application such as Netbook, and similar devices.

The electronic device 200 may include a bus 201, one or more processors 205, a main memory 210, a read-only memory (ROM) 215, a storage device 220, one or more input devices 225, one or more output devices 230, and a communication interface 235. Bus 201 may include one or more conductors that permit communication among the components of the electronic device 200.

Processor 205 may include any type of conventional processor, microprocessor, or processing logic that interprets and executes instructions. Moreover, processor 205 may include processors with multiple cores. Also, processor 205 may be multiple processors. Main memory 210 may include a random-access memory (RAM) or another type of dynamic storage device that stores information and instructions for execution by processor 205. ROM 215 may include a conventional ROM device or another type of static storage device that stores static information and instructions for use by processor 205, Storage device 220 may include a magnetic and/or optical recording medium and its corresponding drive.

Input device(s) 225 may include one or more conventional mechanisms that permit a user to input information to the electronic device 200, such as a keyboard, a mouse, a pen, a stylus, handwriting recognition, touch screen display, voice recognition, biometric mechanisms, and the like. Output device(s) 230 may include one or more conventional mechanisms that output information to the user, including a display, a projector, an A/V receiver, a printer, a speaker, and the like. Communication interface 235 may include any transceiver-like mechanism that enables the electronic device 200 to communicate with other devices and/or systems. For example, communication interface 235 may include mechanisms for communicating with another device or system via a network, such as network 130 as shown in FIG. 1.

As will be described in detail below, electronic device 200 may perform operations based on software instructions that may be read into memory 210 from another computer-readable medium, such as data storage device 220, or from another device via communication interface 235. The software instructions contained in memory 210 cause processor 205 to perform processes that will be described later. Alternatively, hardwired circuitry may be used in place of or in combination with software instructions to implement processes consistent with the present application. Thus, various implementations are not limited to any specific combination of hardware circuitry and software.

A web browser comprising a web browser user interface may be used to display information (such as textual and graphical information) on the electronic device 200. The web browser may comprise any type of visual display capable of displaying information received via the network 130 shown in FIG. 1, such as Microsoft's Internet Explorer browser, Mozilla's Firefox browser, Apple's Safari browser, Google's Chrome browser or any other commercially available or customized browsing or other application software capable of communicating with network 130. The electronic device 200 may also include a browser assistant. The browser assistant may include a plug-in, an applet, a dynamic link library (DLL), or a similar executable object or process. Further, the browser assistant may be a toolbar, software button, or menu that provides an extension to the web browser. Alternatively, the browser assistant may be a part of the web browser, in which case the browser would implement the functionality of the browser assistant.

The browser and/or the browser assistant may act as an intermediary between the user and the electronic device 200 and/or the network 130. For example, source data or other information received from devices connected to the network 130 may be output via the browser. Also, both the browser and the browser assistant are capable of performing operations on the received source information prior to outputting the source information, Further, the browser and/or the browser assistant may receive user input and transmit the inputted data to devices connected to network 130.

Similarly, certain embodiments of the present application described herein are discussed in the context of the global data communication network commonly referred to as the Internet. Those skilled in the art will realize that embodiments of the present application may use any other suitable data communication network, including without limitation direct point-to-point data communication systems, dial-up networks, personal or corporate Intranets, proprietary networks, Cloud network, or combinations of any of these with or without connections to the Internet.

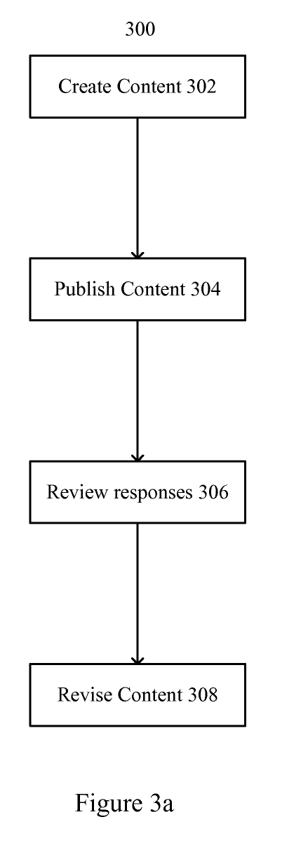

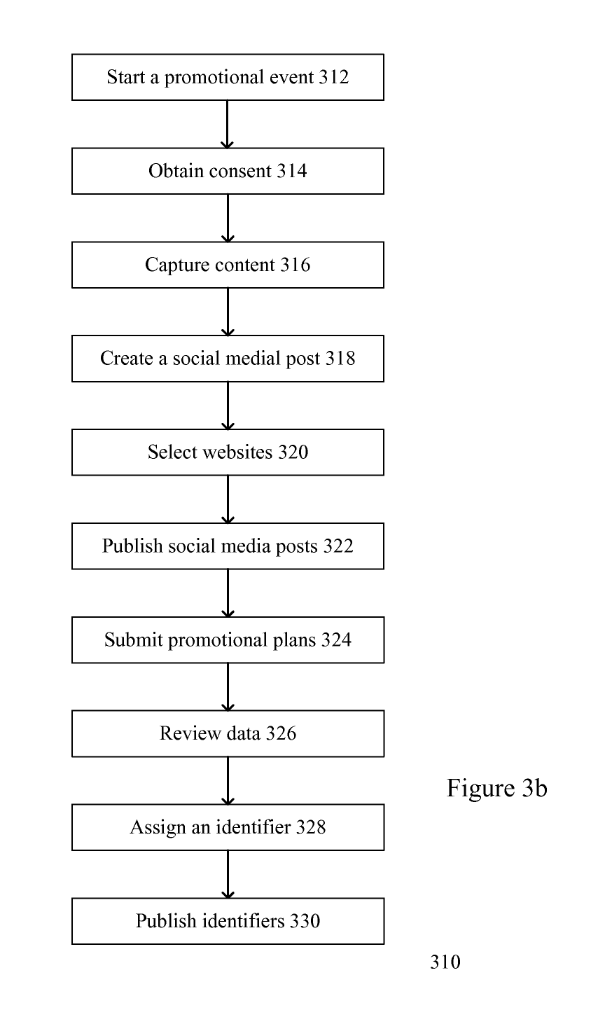

FIG. 3a illustrates an overview of a social media content management method 300 according to an embodiment of the present application. The method 300 includes a step 302 for creating social media content, such as a promotional event on a social platform, a step 304 for publishing the social media content, a step 306 for reviewing responses to the published social media content, and a step 308 for revising the published social media content according to an outcome of the step 306. In step 302, a promotional event such as a social media post is created to be published on a social platform. According to an embodiment, the social media post uses information of a third party, such as name, picture, address, video, testimony, or interview of a real customer, as part of the social media post. According to an embodiment, the information of a real customer may be uploaded by the customer to a dealer's device. According to an embodiment, the information of a real customer may be captured at a dealer's physical location after a transaction between the customer and the dealer is completed. The information of a real customer may include an image of the customer showing satisfaction with the transaction. According to an embodiment, the information of a real customer may be captured from a social media post published by the same customer. For example, if the customer publishes his or her car buying experience with the dealer on a social network, the dealer may be able to discover the post and may capture images or comments in that post to create the promotional event. According to en embodiment, consent of the customer for using his or her information may be obtained before the creation and publication of the promotional event. in step 320, after the promotional event is created, a social media manager of the dealer may review the content of the promotional event, thus maintaining a consistent image and reputation of the dealer on a plurality of social platforms.

The term “third party” as used in this application, in general, includes any person, party, institution, organization, agency, or company who may have an interest in a publishable content. The third party may be a creator of the content, an owner of the content, a publisher of the content, who has a license to use the content, who has control of the content, or who is part of the subject as described, shown, expressed, or included in the content.

In step 304, social networks are selected to publish the promotional event. Social networks are selected based on a plurality of criteria, including whether the dealer has an account or not, how many social connections the dealer has on a social network, what is the subject of a specific social connection group, and/or what the geographical distributions of connections among local and national regions are, One or more social networks may be selected for publication. The step 304 allows the dealer to publish a promotional event on plural social networks simultaneously, such as by using “one click” function to publish a promotional event in multiple social networks. The step 304 also allows the dealer to schedule the publication of a promotional event or plural promotional events. According to an embodiment, the selected websites and the schedule to publish the promotional event are also reviewed and approved by a social media manager of the dealer.

In step 306, social medial data, such as responses to the published promotional event, are aggregated and reviewed. Data such as comments, likes, dislikes, questions, and critics are obtained from each social network and presented to the dealer. The dealer may choose to view the data as it is or in a re-organized form. The deal may choose to view the analysis of the social media data in addition to the raw data. According to an embodiment, the dealer is provided the ability to obtain all real time responses in his or her devices by using a streaming function. The dealer may choose to view a specific type of responses such as wall posts or tweets. The dealer may choose to view data on a specific social network, and/or view data in a specific time period. In step 306, statistical analysis of the data is also provided to a dealer such that the dealer is aware of the trend of responses to the promotional event along a time period, among social networks, across plural regions, arid/or other factors that the dealer may have interests

In step 308, the dealer is provided with a function to reply to a response on a social network. The dealer is also provided with a function of revising the published promotional event based on the analysis of step 306. After a revised content is created, the method may go back to step 302. Such iteration may continue until the dealer is satisfied with the promotional event.

FIG. 3b illustrates a method 310 for creating a social media promotional event. In block 312, a promotional event occurs between one or more representatives of a promoting entity and a third-party. The promoting entity may be a natural person, business, not-for-profit organization, or government agency. Tice promotional event relates to the overall purpose or function of the promoting entity and is an activity that is intended to be published across one or more designated websites, such as social media websites. Moreover, the promotional event may be commercial (e.g., the purchase or a product or service) or non-commercial (e.g., non-profit services), The third-party may be a natural person, business, not-for-profit organization, or government entity.

In block 314, the representative accesses a software module on an electronic device to begin the process of creating social media promotional content. The representative may obtain consent from the third-party to capture content associated with the promotional event. The consent can be presented as a paper form or displayed electronically on the screen of an electronic device. The third-party may receive compensation in the form of payment, coupon, or some other benefit from the entity before or after consenting to the use of the third-party's likeness and information.

In block 316, the representative utilizes an electronic device to capture content associated with the promotional event involving one or more third-parties. The content associated with the promotional event may include a photograph or video of the third-party participating in the promotional event. The computing device can be any electronic device capable of capturing text, video, and/or photo content through a user interface. The electronic device is also capable of connecting to the Internet via Ethernet, cellular network, or to another device that can do so, The electronic device can include, but is not limited to, a cellular phone, tablet, camera, and/or PC or laptop computer.

In block 318, the representative creates a social media post based on the captured content in a software module contained on the electronic device. The social media post may include the captured content (i.e., the photo or video of the third-party participating in the promotional event), and a textual description of the same. The textual description may include pre-set parameters, such as date, geolocation, and/or the promoting entity's name. Additionally, the social media post may be customized to the promotional event within the software module. Examples of custom content may include third-party name, a description of the promotional event, phrases, icons, or the like.

In block 320, the representative selects websites for publishing the created social medial post. The publication may be in a broadcast form or a targeted form. In the broadcast form, the representative may select the dealer's website, his or her own blog, or a publication function provided by a social platform and having no restrictions on who can view the content provided by the publication function. In the targeted form, the representative may select his or her friends or connections in a social network websites and provide the social media post directed to their email address, wall post, and text message boxes.

In block 322, the representative publishes the social media post on one or more social networks. According to an embodiment, the representative publishes the promotional event by using the publication function of each platform. According to an embodiment, the block 322 provides a function that allows a user to publish a promotional event on plural social platforms with one click of a button on a user interface. After the social media post is published, the software module uploads the data associated with the social media post to a storage device associated with the promoting entity.

In blocks 324 and 326, a social media manager receives data representing the social media post. For example, the social media manager may receive the data from a storage device. The social media manager is responsible for editing and managing social media content associated with the promoting entity. The social media manager may review the content to ensure that it complies with the content policies set by the promoting entity. The content policies may be preprogrammed by the social media manager. By way of example, the pre-set parameters may include screens for offensive or other undesirable content. The social media manager can be fully computerized and proceed to complete screening without any user intervention in accordance with programming. In the case of a computerized social media manager, it may reside on a back-end server. Optionally, the social media manager can be an administrator who edits and approves the social media content through a user interface. The use interface may be custom-designed for each promoting entity.

In block 328, the social media manager approves the social media post and assigns a unique identifier to the content. By way of example, the unique identifier may be a URL. or any other search engine optimization technique that is known in the art. The social media manager may determine the presentation format of the URL format. The URL format may be a full URL, an embedded text, or abbreviated in some other manner,

In block 330, the unique identifier is published to one or more designated website(s) associated with the promoting entity, The websites may be automatically designated by the social media manager, or the administrator may manually select them. These websites can include: one or more of the promoting entity's websites, the representative's Hog on the promoting entity's website, and any social networking site associated with the promoting entity.

By way of example, the promoting entity's social networking sites can include, but are not limited to, Facebook, Instagrarn, Yelp, Twitter, FourSquare, Google+, Tumblr, and LinkedIn.

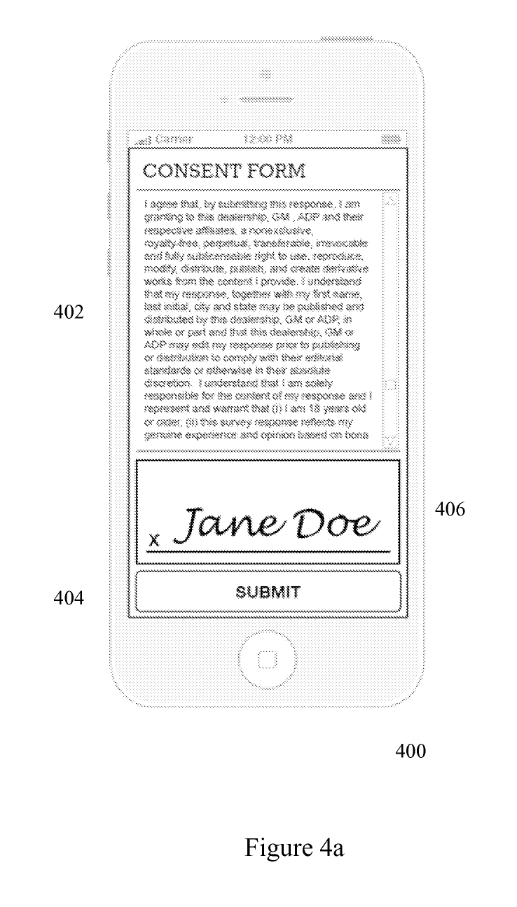

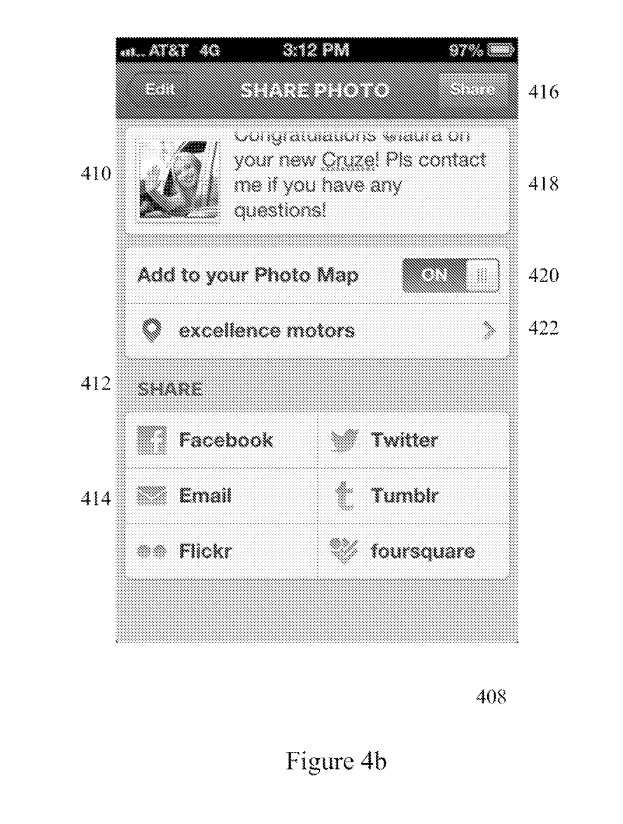

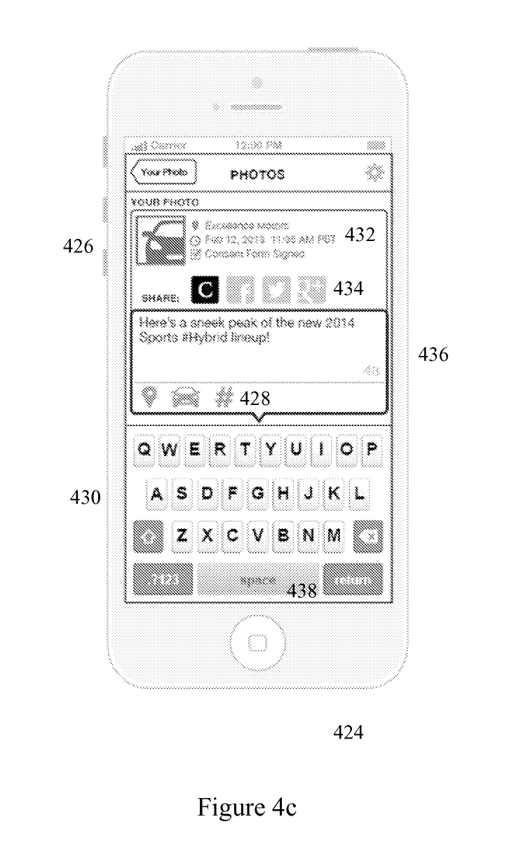

FIG. 4a illustrates a method 400 for obtaining consent regarding the use of the social media content from the third-party. The computing device displays the terms of the consent form 402 to the third-party, such as a real customer. The terms of the consent form 402 may indicate, among things, that the promoting entity is authorized to use the third-party's name and likeness in a social media post. If this is acceptable, the third-party may sign his name on the signature line 406. The user is provided with a function 404 that submits the consent form electronically to the software module and the representative may proceed to capture content, such as images, videos, or texts published by the thirty patty on a social platform.

FIG. 4b illustrates a method 408 for creating a promotional event based on a captured content for an automotive dealership. The automotive dealership's promotional event may be related to a customer's purchase or lease of a vehicle (e.g., car, truck, motorcycle, ATV) from a sales representative. After the sale or lease, the sales representative will log-in to the dealership's social media software module/app that is accessed by a computing device. The computing device displays a user interface 408 where the representative can create a social media post based on the captured content. The captured content 410 may be a photograph of the third-party (customer) who purchased a vehicle from the automotive dealership. The representative enters textual information regarding the vehicle purchase in a text box 418 on the user interface 408 to create a social media post. The social media post may include the captured content 410 and textual information. The representative may tag the customer's name, the car make/model, and a custom message in the text box 410. Additionally, the user interface 408 may have geolocation and dealership information 422, such as the dealership name. Optionally, the representative may choose to add the captured content 410 to a Photo Map 420 that contains all of the representative's photographs related to promotional events, The representative designates one or more social networking websites 414 of which he is a member to publish the social media post. The one or more designated websites 414 may include social networking websites, including but not limited to Facebook, Twitter, Flickr, Tumblr, or foursquare. Another example of a designated website 414 includes an email address. The representative can upload the social media post to be published on the one or more designated websites by using the “share” function 416 after the social media post is reviewed and approved by a manager. Once the social media post is published, the customer may be tagged within her own social networking websites. Tagging can occur based on search optimization techniques and other similar techniques that are known in the art.

FIG. 4c illustrates a method for reviewing a social media post created based on captured content for an automotive dealership. A manager can log-in to the dealership's social media software module/app that is accessible by an electronic device. The electronic device displays a user interface 424 where the manager can review a social media post created by representatives. The captured content 426 includes a photograph of the third-party (such as a customer) who purchased a vehicle from the automotive dealership. The user interface 424 will have a keyboard 438 to input textual information to comment on the created social media post. Adjacent to the captured content 426, important information about the social medial post is outlined in the portion 432, such as the name of the dealership, the scheduled publication time, and whether the customer has provided consent or not. In the portion 434, the selected websites used for publication are displayed. The textual information will appear in the text box 436 of the user interface 424. The text box 436 may limit the amount of characters allowed to describe the promotional event. The text box 436 may also include tags 428 to indicate geolocation, car identifying information, and social networking hashes.

The social media manager is responsible for editing and managing social media content associated with the promoting entity. The social media manager will review the content to ensure that it complies with the content policies set by the promoting entity. These content policies can, for example, relate to screening for appropriate language and be pre-programmed by the social media manager. By way of example, the pre-set parameters may include screens for offensive or other undesirable content. The social media manager can be fully computerized and proceed to complete screening without any user intervention in accordance with programming. Optionally, the social media manager can be an administrator who edits and approves the social media content through a user interface. The user interface may be custom-designed for each promoting entity.

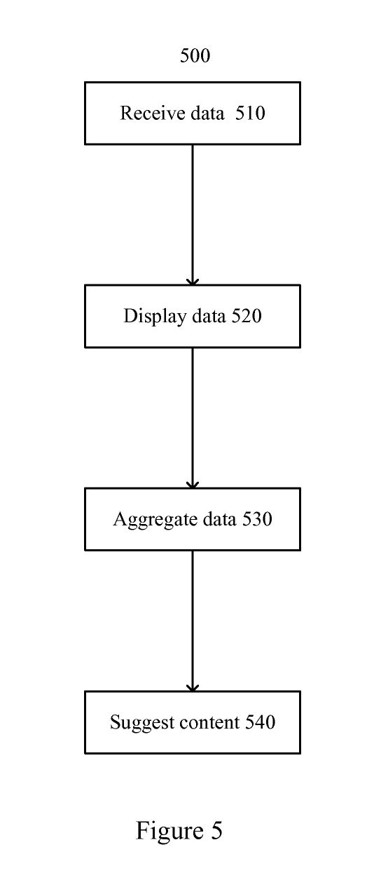

FIG. 5 illustrates a method 500 for managing responses to social media post. In block 510, a social media manager receives a plurality of responses regarding a social media post of a promoting entity. The plurality of responses include one or more social media posts that were published by whoever reads the social medial post.

Additionally, the social media manager will receive data related to third-party interactions with the social media posts on the one or more designated website(s). Specifically, the social media manager will receive alerts when third-parties interact with the URL representing the social media post. By way of example, third-patty interactions include re-sharing, new follower alerts, hashtag mentions, check-ins, “likes”, messages, comments, or click activity.

In block 520, the plurality of data associated with the published social media post is displayed on a user interface. The user interface displays information related to the promoting entity's social media promotional content on social networking platforms and on any other designated websites, such as the promoting entity's home page or blog.

In block 530, the social media manager will aggregate the plurality of data associated with the social media content and third-party interactions with the social media content. The social media manager may also aggregate data associated with the promoting entity's social media content that is stored in a database or other storage device. Additionally, the social media manager may access information related to the third-party's previous promotional activities that are stored in the database. Similarly, the social, media manager may update the third-party database with the current promotional content for future use.

In one embodiment, the social media manager for an automotive dealership may access previous sales information contained in a database 160. The database may contain information related to previous customers who purchased or leased vehicles. The database may also contain information related to the sales activity of its representatives. Additionally, the social media manager can update information contained in its customer and representative databases, respectively, with the data contained in the social media posts.

In block 540, the social media manager will generate social media content based on the third-party interactions with the plurality of social media data. The social media manager can create new social media content to be posted on its own webpage or own social networking websites based on the plurality of social media data. By way of example, the new social media content can be a message or event for the promoting entity. The new social media content can be scheduled or calendared according to a particular date or time. Additionally, the social media manager can generate responses to the third-party interactions via public or private comments or messages.

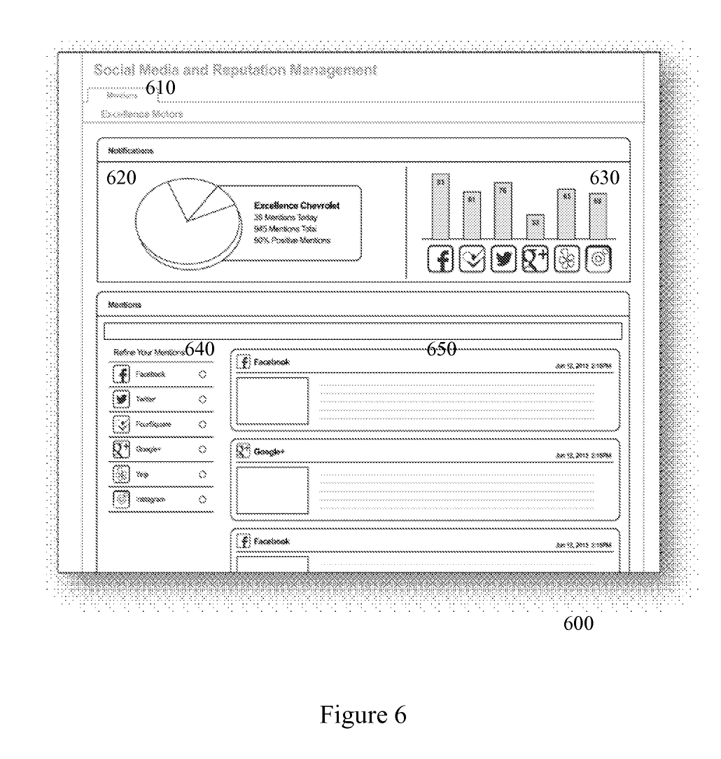

FIG. 6 illustrates a method 600 of analyzing responses to a social media post according to an embodiment of the present application. The user interface 600 displays data related to third-party interactions from social media networks with the promoting entity's social media content. The user interface 600 may contain a tab related to monitoring social media mentions 610. The monitoring tab 610 contains all of the data related to third-party mentions of the promoting entity. The user interface 600 displays a notifications section 620 regarding the number of total or daily mentions of the promoting entity. Additionally, the notifications section 620 may include whether the sentiment associated with the social media mentions were positive or negative. The notification section 620 may also categorize the mentions according to the social networking website in the section 630. This categorization 630 can be represented graphically or numerically.

The user interface 600 may also have a refine section 640 whereby the promoting entity can review third-party mentions associated with a particular social networking website. In this embodiment, the third-party mentions associated with Facebook can be displayed for review in the section 650.

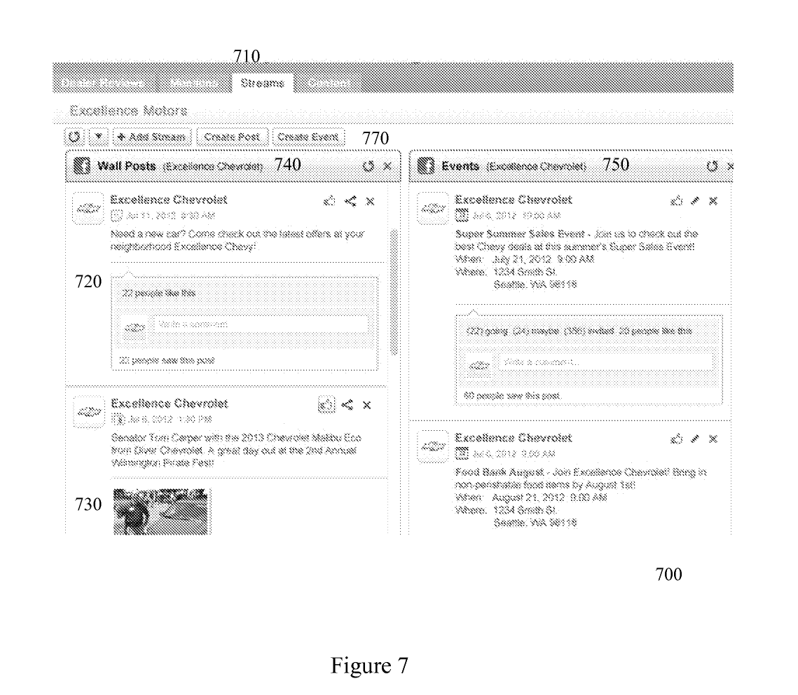

FIG. 7 illustrates a user interfaces 700 for reviewing social media streams for an automotive dealership. The user interface 700 displays data related to third-party interactions from social media networks with the promoting entity's social media content. The user interface 700 may contain a tab 710 related to social media contents such as stream, dealer reviews, mentions, and content. The management tab 710 contains all of the data related to the content and third-party interactions with the promoting entity's social media presence in a single user interface. In this embodiment, the user interface 700 will organize each stream of social networking content in a column format based on the type of social media posts such as wall post 740 and events 750. According to an embodiment, the user interface may organize streams according to social networking websites such as Tweeter and Google+. For example, the streams of social n network content may include a Facebook newsfeed, Facebook wallposts, twitter home feed, Twitter tweets, and Google+wall posts. In this embodiment, the user interface 700 contains streams of the social networking content. The promoting entity can customize the user interface 700 to add or delete social networking streams based on preference or importance by using functions 770. The user interface 700 also allows the promoting entity to review a specific piece of social media content 720 and 730 in a particular' column such as column 740. Additionally, the user interface 700 allows the promoting entity to respond to third-party messages on the social networking websites and add or respond to events listed on a social networking website.

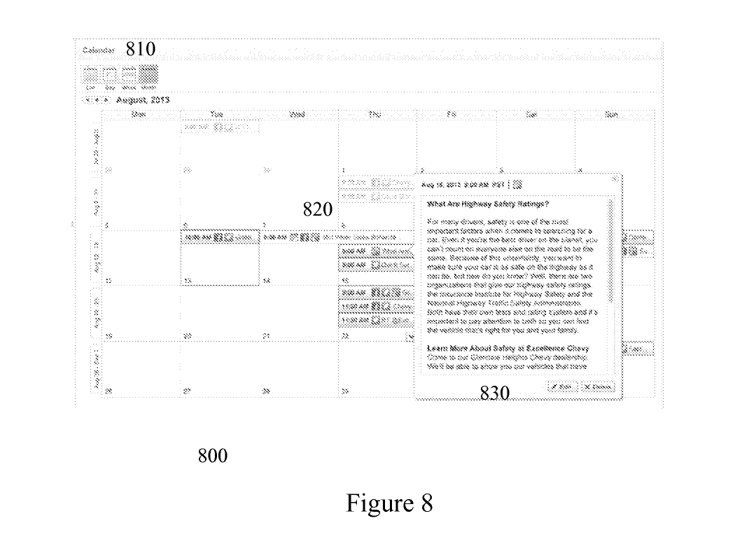

FIG. 8 illustrates a method 800 for authoring and scheduling social media content. The user interface 800 contains a specific tab 810 related to authoring and scheduling social media content. The tab 810 in this embodiment selects a monthly calendar form, but a daily or weekly form r ay also be contemplated. The promoting entity administrator may select a particular date and time 820 on the user interface 800 to schedule the publication of social media content 830. In the user interface 800, the promoting entity administrator can create content 830 to be published on one or more selected social media websites. For example, the content 830 can be a photograph, video, sales special, car maintenance recommendation, safe-driving tip, third-party article, discussion point, comment, or other advertisement regarding the promoting entity. Additionally, the promoting entity administrator can designate 820 one or more websites to publish the social media content 830. If revisions are required for the social media content 830, the promoting entity can use the user interface 800 for editing 830.

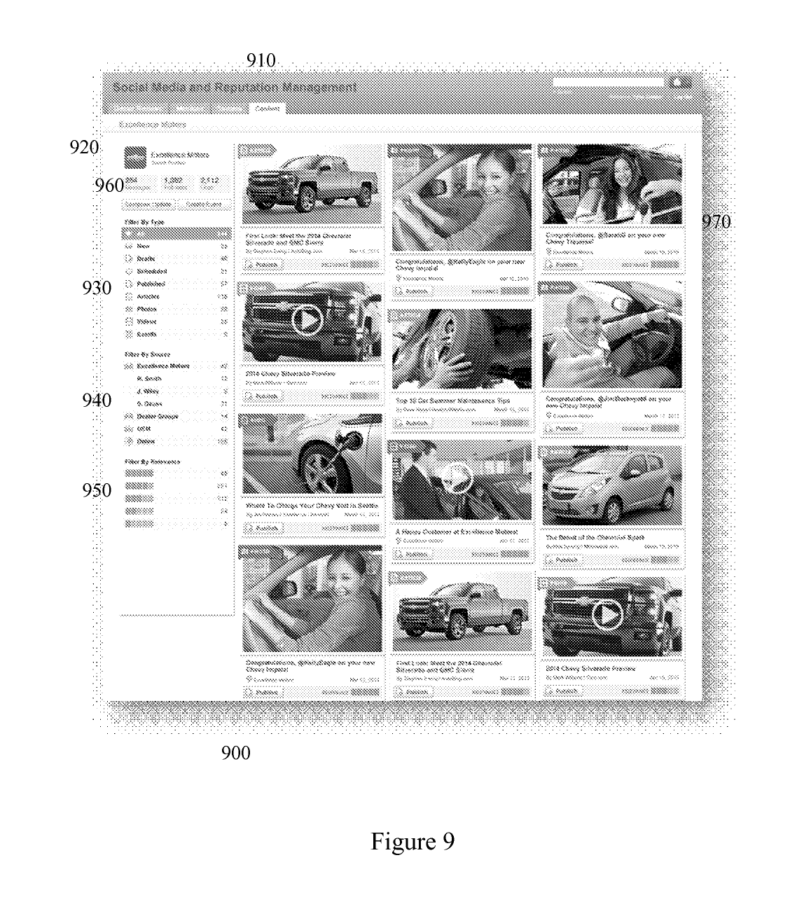

FIG. 9 illustrates a user interface 900 for managing and responding to social media content for an automotive dealership. The user interface 900 is accessed by an administrator or other authorized individual associated with the promoting entity. The administrator to generate social media content based on representatives' social media postings. The user interface 900 is branded according to the automotive dealership's specifications and contains a specific tab to access the content generation section 910. The administrator can review all of the data related to the promoting entity's social media presence 920. This data 920 may include all of the dealership's social media messages, followers, and/or likes. The user interface 900 also has one or more social media content filters 930, 940, and 950. In this embodiment, the user interface 900 can filter the social media content by type 930, source 940, or relevance 950. For example, filtering by type 930 can include parameters such as new, drafts, scheduled, published, articles, photos, videos, or events. Additionally, filtering by source 940 can be by sales representative, dealer groups, OEM, or online sources. Lastly, filtering by relevance 950 can range from least relevant to most relevant. The administrator may also manually update or create an event 960. Furthermore, the user interface 900 can also generate recommended messages of relevant, criteria-based media rich content 970. The generated content 970 can sync with the social media content previously posted by its sales representatives, The generated content 970 will include the dealership name, a date and time stamp, a photo/article/video/blog entry, and a short textual message regarding the post, The generated content 970 can be posted immediately or scheduled to post in the future.

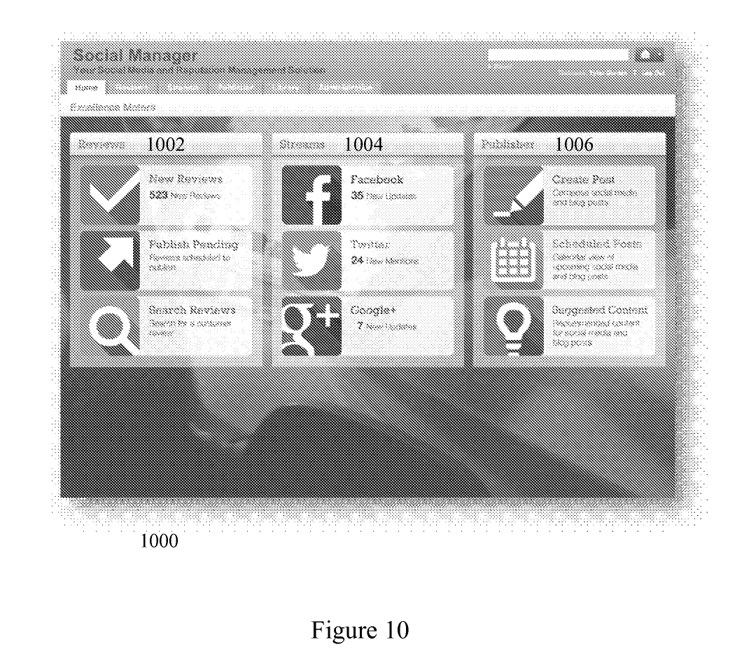

FIG. 10 illustrates a dashboard screen 1000 according to an embodiment of the present application. The dashboard screen 1000 includes a plurality of social media management functions to provide an efficient user interface to a user. The dashboard screen 1000 includes a review function 1002, a stream function 1004, and a publishing function 1006.

The review function 1002 allows a user to review responses to a promotional event. The review function 1002 aggregates all reviews based on a predetermined interval such as every day, every two days, every week, and/or every month. The review function 1002 separates new reviews from those that have been viewed by the user and reminds the user the number of new reviews. The review function 1002 also allows the user to search reviews and to view those reviews that are publish pending.

The stream function 1004 allows a user to obtain responses in real time. The user can designate plural social networks in the dashboard to have an instant comprehension of the real time reviews of a promotional event. The publisher function 1006 includes a post creating function, a publication schedule function, and a content suggestion function.

The particular embodiments disclosed above are illustrative only as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A computerized method of creating social media promotional content, comprising;
receiving, by at least one computing device, a promotional event involving a third party;
generating, by the at least one computing device, a consent request to obtain consent from the third party to publish the promotional event;
generating, by the at least one computing device, a first social media post based on the promotional event to publish at a first social media website; and
generating, by the at least one computing device, a second social media post based on the promotional event to publish at a second social media website,
wherein the first media post and the second media post each contains a unique identifier.

2. The computerized method of claim 1, wherein the promotional event includes an image uploaded by a user.

3. The computerized method of claim 1, wherein the promotional event includes a social media post.

4. The computerized method of claim 1, wherein the promotional event includes an URL of a social media post.

5. The computerized method of claim 1, wherein the promoting event involves sale of an item by a promotional entity.

6. The computerized method of claim 1, wherein the first social media website is a blog.

7. The computerized method of claim 1, wherein the unique identifier includes an URL.

8. The computerized method of claim 1, wherein the unique identifier includes an embedded text.

9. A computer system for creating social media promotional content, comprising:
a receiving section that receives a promotional event involving a third party, and
a generating section that generates a consent request to obtain consent from the third party to publish the promotional event, a first social media post used on the promotional event to publish at a first social media a website, and a second social media post based on the promotional event to publish at a second social media website.
wherein the first media post and the second media post each contains a unique identifier.

10. The computer system of claim 9, wherein the promotional event includes an image uploaded by a user.

11. The computer system of claim 9, wherein the promotional event includes a social media post.

12. The computer system of claim 9, wherein the promotional event includes an URL of a social media post.

13. The computer system of claim 9, wherein the promotional event involves sale of an item by a promotional entity.

14. The computer system of claim 9, wherein the first media website is a blog.

15. The computer system of claim 9, wherein the unique identifier is an URL.

16. The computer system of claim 9, wherein the unique identifier is an embedded text.

17. A computer-implemented method of creating social media promotional content, comprising:
receiving, by at least one computing device, a social media post by a third party;
generating, by the at least one computing device, a first social media post based on the social media post by the third party to publish at a first social media website; and
generating, by the at least one computing device, a second media post based on the social media post by the third party to publish at a second media website,
wherein the first social media post and the second social media post each contains a unique identifier.

18. The method of claim 17, further comprising:
reviewing, by the at least one computing device, at least one response to the first social media post and at least one response to the second media post; and
generating, by the at least one computing device, additional social media posts based on the social media post by the third party.

19. The method of claim 18, wherein the first media website is a blog.

20. The method of claim 18, further comprising:
selecting, by the at least one computing device, from a plurality of social media posts by the third party, one social media post as a promotional event; and
generating, by the at least one computing device, a social media post based on the promotional event.
